(19) United States
(12) Patent Application Publication
(10) Pub. No.: US 2002/0124184 A1
(43) Pub. Date: Sep. 5, 2002

(54) Method and system for automated request authorization and authority management

(76) Inventors: Ashok L. Fichadia, Omaha, NE (US); Kyle J. Haynes, Omaha, NE (US); George R. Johnson, Papillion, NE (US)

Correspondence Address: MCKEE, VOORHEES & SEASE, P.L.C., 801 GRAND AVENUE, SUITE 3200, DES MOINES, IA, 50309-2721, US

(21) Appl. No.: 09/797,370

(22) Filed: Mar. 1, 2001

(51) Int. Cl. G06F 12/14; G06F 17/60

(52) U.S. Cl. 713/201; 713/166; 705/44

(57) ABSTRACT

A method and system for automated request authorization and authority management is provided with at least a requestor-operated interface, having at least a display device and input device, and server, having at least a processor, a memory device, and management software. The method and system enables a user to formulate a request on a request template displayed on the interface by the server. The completed request is automatically transmitted via a network connection to the server for selective distribution to at least one request approver-operated interface, whereby one or more request approvers review the request. Rejected requests are returned to the requester with an explanation and/or instructions regarding the rejection. Approved requests are processed. An engine is provided for automatically processing and completing selected specified request types. The system and method further provide the user with the ability to monitor the status of the request.

### BACKGROUND OF THE INVENTION

1. Field of the Invention

The present invention relates to the field of request authorization and authority management systems, and more particularly to an authorization and authority management system that operates via a computer network, which automates the system and the granting of authority requests therein.

2. Description of the Related Art

Many businesses use computer resources for their daily operations. These resources contain information that may be proprietary or otherwise be of a sensitive nature. In order to protect these resources, the businesses typically restrict access to the resources through the use of access control lists or a computer security barrier or “firewall.” Access is granted to employees or other individuals on a person by person basis depending on the employee, the resource, and the level of restriction placed on the resource.

Typically, businesses use manual request management systems where, for example, an employee will complete a handwritten request for access to a secure database owned by the business or third-party resource owner. The employee manually routes the request to a supervisor who may approve or deny the request. If the request is approved, the written request is then manually forwarded to the resource owner where, if approved, it will be given to a security group who will manually enter the required data and open a new account in the secure database for the requesting employee.

This method of manually delivering a written request from department to department for approval and entry can literally take days, if it is completed at all, due to human error or an incorrect request format. Such a method of request management in large business organizations can be that much more frustrating when the employee's request is not for something as sensitive as secure data access, but for something as trivial as office supplies.

Therefore, there is a need for an improved authorization and authority management system that operates via a computer network, which automates the system and the granting of authority requests therein.

### SUMMARY OF THE INVENTION

The present automated request authority management system allows a user, typically an employee of a business, to efficiently and quickly submit a request through the chain of command and obtain the requisite approval. One type of request that can be made using the present system is an employee's request for access to sensitive or proprietary computer resources owned by the employer or other third party vendor. Other requests can be as simple as an employee's request for office supplies. The system's versatility and efficiency make it adaptable to an infinite number of business applications.

The system comprises at least one interface, having at least a display and data input means, and a server. To initiate the process, the user selects or “clicks” on an application icon shown on the user's display. The server generates a request form on the user's display which is completed by the user with the required information and request parameters. The user's request preferences can be simply stored on the server in a profile document that is later accessed for generating repeat or similar requests. A server database serves as a data store to store all of the requests and allows users the opportunity to check the status of their requests. The request has a status field that changes to reflect the status of the request, i.e., in progress, under review, being processed, manually completed, completed by the automation engine, and user informed.

Once the user has completed the request, it is processed by the server, which seeks the approval or denial of each of the defined authorities in a predetermined (customizable) sequence. For example, where a departmental approver is defined for the individual making the request, an e-mail message is sent to that approver along with the request for approval. The departmental approver follows a link in the e-mail message to the exact request. The departmental approver then allows or rejects the request. If a rejection is entered, the system sends an e-mail message back to the requester for correction or abandonment of the request. If the request is approved, the system notifies the resource owner of the user's request via an e-mail message. Similarly, the resource owner is able to allow or reject the request. If the request is allowed, the system forwards the request to the security administrators for final approval and processing.

For requests that have been automated by the resource owner, the system engine activates at predefined intervals and processes the requests that have been approved by the security administrator. Those requests that are not automated are processed at the security administrator level by hand. Upon completion of the request, the engine updates the data store to reflect the status of the request and identifies any errors that may have occurred during processing.

Thus, a primary objective of the invention is to provide a method and system for automating request authorization and authority management.

Another objective of the invention is to provide an automated request authorization and authority management system that is capable of automatically processing approved requests.

Another objective of the invention is to provide an automated request authority management system that allows for continuous remote status query.

Another objective of the invention is to provide a request authority management system that uses computer automation to decrease overall request processing time.

Another objective of the invention is to provide a request authority management system that uses computer automation to increase system accuracy.

Another objective of the invention is to provide a centralized storage for users' authority levels and the approvers for the authority.

These and other objects will be apparent to those skilled in the art.

### BRIEF DESCRIPTION OF THE DRAWINGS

FIG. 1 is a detailed flow diagram depicting one embodiment of the method of the present invention; and

FIG. 2 is a block diagram generally depicting one embodiment of the present invention.

### DESCRIPTION OF THE PREFERRED EMBODIMENT

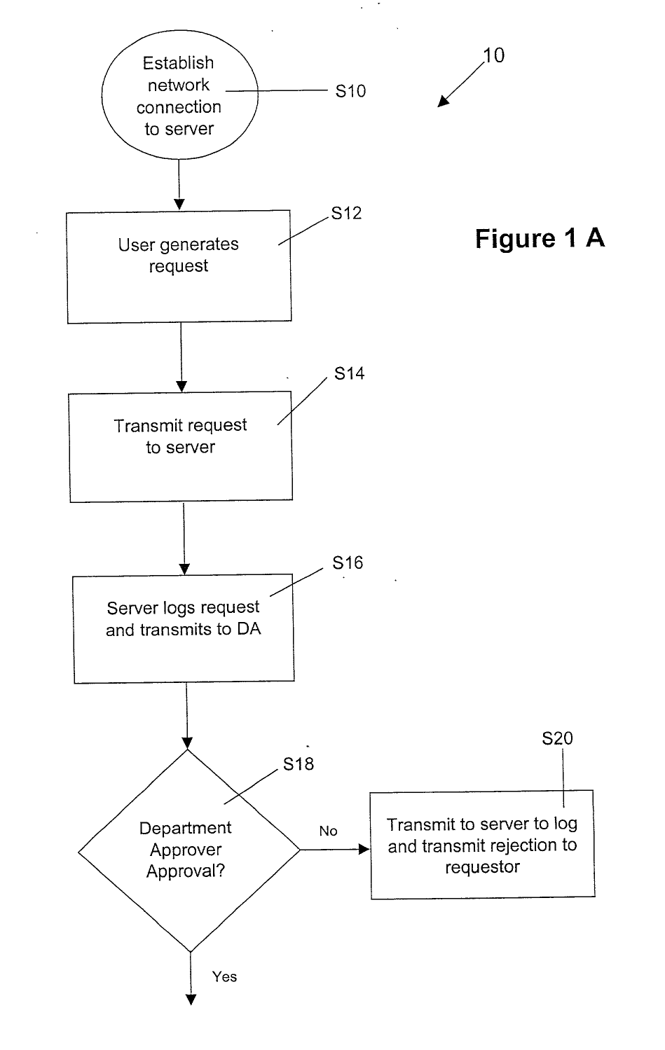

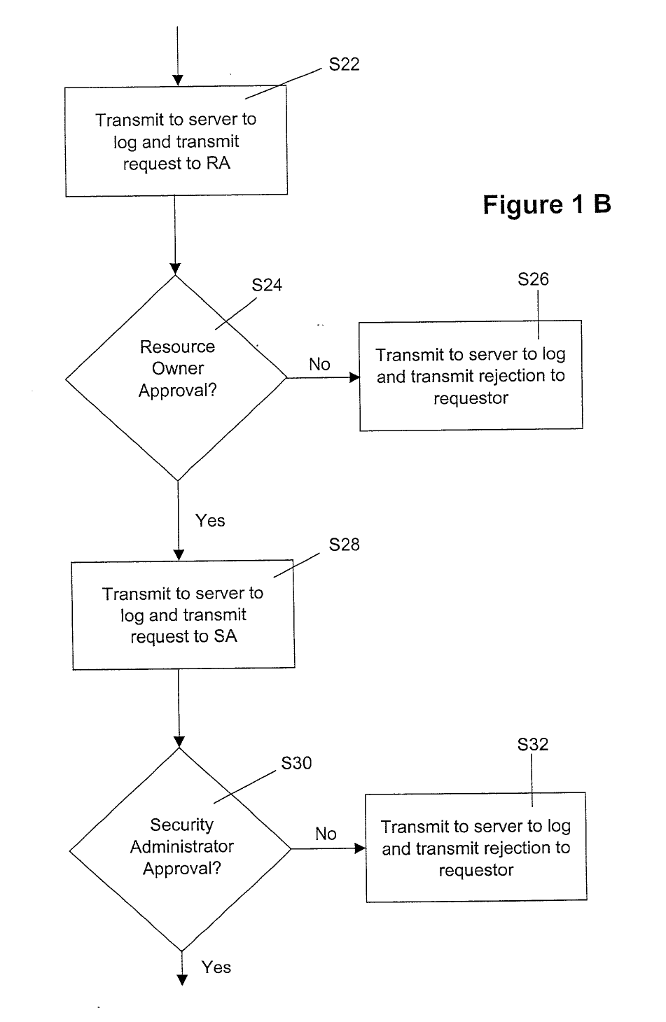

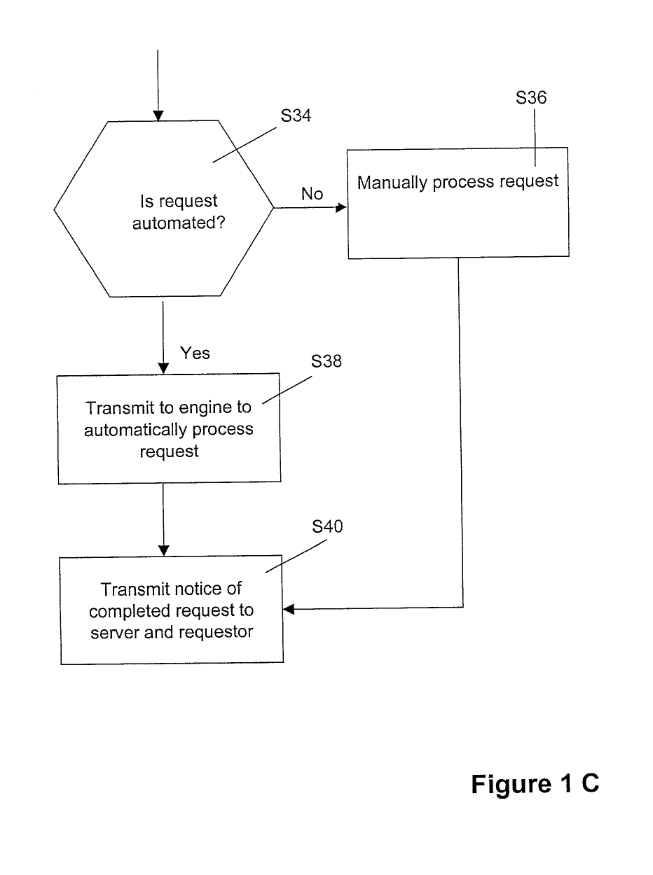

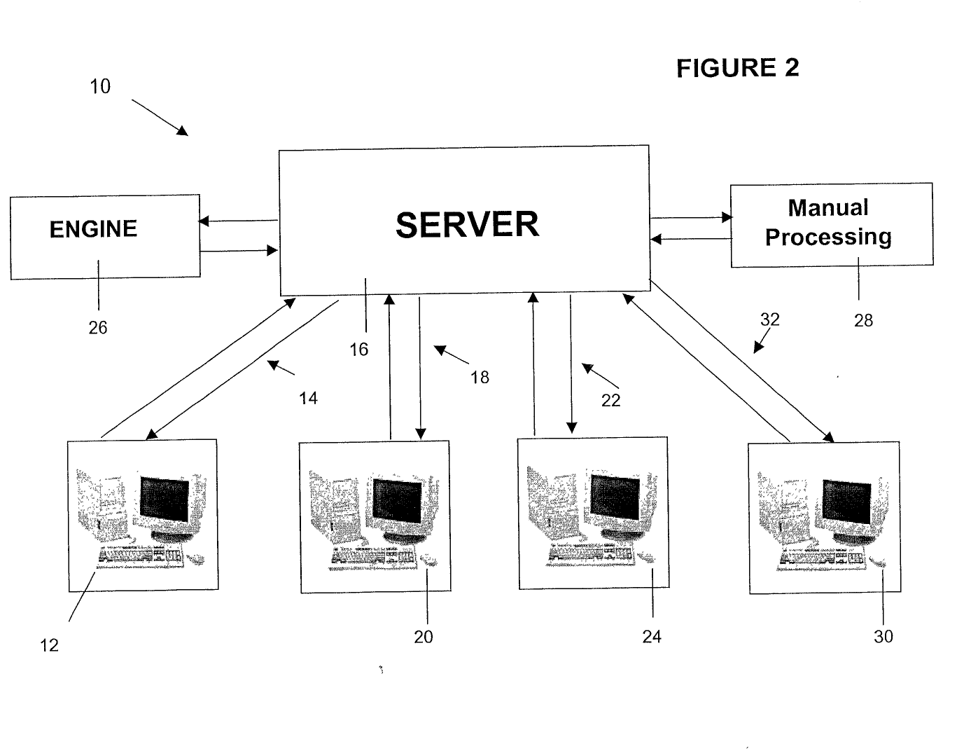

FIGS. 1 and 2 generally depict an automated request authority management system 10 and method of implementing the same that is provided with at least one user-operated interface 12, having at least a display and data input means, and at least one server 16 having at least a processor, an authorization and automation engine application, and data storage means. In the present system, the user operates interface 12, selecting an application icon to initiate a request. A network connection 14 is established between the interface 12 and the server 16 hosting the data store and the application (step S10). One embodiment of such a connection is an Internet connection via the World Wide Web between the interface 12 and the server 16. Other connections, however, such as an intra-office network system could be used.

A request form is presented on the display of the interface 12 by a GUI (Graphic User Interface) application stored on server 16. The request form is completed by the user with the required information and request parameters (step S12). The information can be provided in a structured format or a free-form format. In the initial implementation of the invention, for the structured format, a customized Microsoft Excel spreadsheet is generated on the fly for the user to fill out. For the free-form format, the user is provided with a field to enter text and attach supporting documents, if any are desired. For repeat requests, the user's request preferences are simply stored in a profile document that is later accessed for generating the repeat requests.

In the preferred embodiment, the GUI is created using Lotus Notes software and built-in components, such as buttons, forms, etc., provided by Lotus Notes database, a programming language entitled LotusScript, and Application Programming Interfaces (APIs) into Microsoft Excel. Besides acting as a user interface, the Lotus Notes database also acts as a data store and stores all user requests. The requests have a status field that changes to reflect the status of the request, i.e., in progress, under review, being processed, manually completed, completed by automation engine, and user informed.

Once the user has finished drafting the request, it is transmitted to server 16 via network connection 14 (step S14). A LotusScript code within the database on server 16 seeks authorization from the defined authorities in a predetermined (customizable) sequence. For simple requests, the processor of server 16 could be made operable to receive and approve or reject the request in accordance with previously identified criteria. However, the typical application involves request approval and management from individuals working at different stations within a company. Where a departmental approver 20 is defined for the individual making the request, an e-mail message is sent to that approver 20 along with the request for approval (step S16) via network connection 18. The departmental approver 20 follows a link in the e-mail message to the exact request. If the departmental approver 20 feels that the request is justified (step S18), the request is approved. If the departmental approver 20 does not feel that the request should be completed or that there are errors or omissions in the request, the request is rejected. An explanation for the rejection can be attached if the departmental approver so desires. Once the rejection is entered, the system sends an e-mail message back to the requester for correction or abandonment of the request (step S20).

Once the departmental approver 20 has approved the request, the server notifies the resource owner 24 of the user's request via an e-mail message (step S22) sent on network connection 22. Once the resource owner 24 reviews the request, he/she can either approve it or reject it (step S24). If the resource owner 24 rejects the request, he/she also has the opportunity to provide an explanation and then an e-mail message is sent to the requestor for modification or abandonment of the request (step S26).

Once both the departmental approver 20 and the resource owner 24 have approved the request, the final step before the request can be processed is obtaining approval from the security administrator 30 (step S30). If the security administrator 30 rejects the request, he/she also has the opportunity to provide an explanation and then an e-mail message is sent to the requester for modification or abandonment of the request (step S32). Requests approved by the security administrator 30 are then ready to be processed. The server 16 determines whether or not the request has been automated by the resource owner 24 (step S34). For requests that have not been automated the security administrator 30 or other selected individual or department 28 is responsible for manually processing the task requested (step S36). Once complete, the request is marked as complete and filed electronically in the server 16 (step S40).

For requests that have been automated by the resource owner 24, the system engine 26 activates at predefined intervals and processes the requests that have been approved by the security administrator (S38). The engine 26 uses operating system specific API calls to two operating systems, NetWare and Windows NT to perform the requested tasks. Although the types and number of requests that can be processed by the engine 26 are virtually limitless, in the current embodiment, the engine 26 processes twelve types of requests using the two different platforms. Six request types are processed using NetWare 4.0/5.0 and the remaining six request types are processed using Windows NT 4.0. The requests performed include the ability to create or delete user accounts on the NetWare operating system, add or delete groups on the NetWare operating system; add or delete a user to a particular group on the NetWare operating system; create or delete user accounts on the Windows NT operating system; add or delete groups on the Windows NT operating system; and add or delete a user to a particular group on the Windows NT operating system.

The engine 26 also performs validity checks to ensure that the request has not been tampered with or otherwise corrupted. The engine 26 communicates with the platforms via platform-specific API calls to perform the requested task. Upon completion of the request, the engine 26 updates the data store to reflect the status of the request and identifying any errors that may have occurred during processing. Other statistics can also be stored to track the system's progress, such as processing time.

On a periodic basis, a monitoring agent in the Lotus Notes database sends notification messages to the requesters notifying them that their request has been processed or identifying any problems that occur.

The embodiment of the present invention described above is a stand-alone application; however, its modular design lends itself to various alternate uses. One such use is as an Application Service Provider, providing help desk support to various companies. One could eliminate the interface and the workflow and simply use the engine 26 to remotely support various companies for help desk purposes. This could include resetting passwords, creating accounts, etc., for users and LAN administrators. In another application, the system 10 is used as a request system for non-computer resources. For example, one could eliminate the engine 26 and use the interface and the workflow to request and authorize access to non-computer resources, such as staplers, business cards, etc. Essentially, instead of the engine 36 processing the requests, the requests would be manually processed.

In another application, the present system 10 can be used as an add-on product to server/PC management software such as Microsoft's SMS and IBM's Tivoli. These types of software are used to manage, inventory, and deploy software on various PCs and servers. One could eliminate the system's engine 26, maintain the interface and the workflow, and then implement software to management software APIs to fulfill the requests. Finally, one could also plug the present system 10 in with other commonly used shopping cart-type applications by eliminating the interface and using the workflow and the engine 26 with the shopping cart interface.

In the drawings and in the specification, there has been set forth preferred embodiments of the invention and although specific items are employed, these are used in a generic and descriptive sense only and not for purposes of limitation. Changes in the form and proportion of parts, as well as in the substitution of equivalents, are contemplated as circumstances may suggest or render expedient without departing from the spirit or scope of the invention as further defined in the following claims.

Thus it can be seen that the invention accomplishes at least all of its stated objectives.

We claim:

1. A method of request authorization and authority management, provided with at least a requestor-operated interface, having at least a display device and input device, and server, having at least a processor and a memory device, comprising the steps of:
establishing a first network connection between said requestor-operated interface and said server;
defining a request on said requestor-operated interface;
transmitting the request from said interface to said server via said first network connection;
submitting the request to at least one request approver for approval or rejection of the request; and
processing said approved or rejected request.

2. The method of claim 1 wherein said at least one request approver is remote from the server.

3. The method of claim 2 further comprising the step of establishing a second network connection between said server and said at least one request approver.

4. The method of claim 3 further comprising the step of transmitting the request from the server to said at least one request approver interface via said second network connection so that said at least one request approver can review and approve or reject the request.

5. The method of claim 4 further provided with an engine that is operable with said server to automatically process a request approved by said at least one request approver.

6. The method of claim 5 further comprising the step of pre-selecting specific types of requests for automatic processing by said engine.

7. The method of claim 6 further comprising the step of automatically processing approved requests using said engine.

8. The method of claim 4 further comprising the step of manually processing approved requests.

9. The method of claim 4 further comprising the step of transmitting rejected requests to the requester.

10. The method of claim 9 further comprising the step of providing comments in the transmission to the requester in support of the rejection.

11. The method of claim 1 further comprising the step of storing the request on said server.

12. The method of claim 11 further comprising the step of accessing said stored requests from said requestor-operated interface to formulate repeat requests.

13. The method of claim 1 further comprising the step of storing status information regarding the request on said server.

14. The method of claim 13 further comprising the step of automatically updating said status information as the request is reviewed and processed.

15. The method of claim 14 further comprising the step of providing monitoring access to the requester and request approver as to the status of the request.

16. The method of claim 1 wherein the processor is operative on said server to receive the request as the at least one request approver and selectively approve or reject the request.

17. A system for request authorization and authority management, comprising:
a requestor-operated interface, having at least a display device and input device; and
a server, having at least a processor and a memory device;
software means operative on said server for:
a) displaying a request form on said requestor-operated interface display device;
b) receiving a request completed by a requestor on said requestor operated interface;
c) transmitting the request to at least one request approver interface; and
d) receiving an approval or rejection to said request.

18. The system of claim 17 wherein said software means is further operative on said server to store the identity of requests previously selected for automatic processing.

19. The system of claim 18 wherein said software means is further operative on said server to automatically process approved requests that were previously selected for automatic processing.

20. The system of claim 17 wherein said software means is further operative on said server to selectively transmit manual processing notices to individuals or departments responsible for manually processing approved requests.

21. The system of claim 17 wherein said software means is further operative on said server to transmit notices, to the requester, that the request had been rejected.

22. The system of claim 17 wherein said software means is further operative on said server to store the request.

23. The system of claim 22 wherein said software means is further operative on said server to provide requester access to said stored request, via said requestor-operated interface, to formulate repeat requests.

24. The system of claim 17 wherein said software means is further operative on said server to store request status information regarding the request.

25. The system of claim 24 wherein said software means is further operative on said server to automatically update said request status information.

26. The system of claim 25 wherein said software means is further operative on said server to provide monitoring access to the requestor and request approver as to the status of the request.
